(19) United States
(12) Patent Application Publication
(10) Pub. No.: US 2003/0149590 A1
(43) Pub. Date: Aug. 7, 2003

(54) Warranty data visualisation system and method

(76) Inventors: Andrew John Cardno, Wellington (NZ); Donald Woolgar John Bourke, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/354,680

(22) Filed: Jan. 30, 2003

Related U.S. Application Data
(63) Continuation of application No. PCT/NZ01/00157, filed on Jul. 31, 2001.

(30) Foreign Application Priority Data
Jul. 31, 2000 (NZ) 506083

(51) Int. Cl. G06F 17/60

(52) U.S. Cl. 705/1; 705/7

(57) ABSTRACT

The invention provides a data visualisation system comprising a data value memory in which is maintained an interaction database of interaction data representing interactions between the customers and merchants involving one or more items; a retrieval device configured to retrieve from the interaction database data representing interactions between customers and merchants and to construct a finite set of data values from the retrieved data; and a display arranged to display a graphical representation of at least one item, and to superimpose one or more contoured representations of the data values on the graphical representation of the item such that each data value is displayed as a local maximum. The invention also provides related methods and computer programs.

### FIELD OF INVENTION

The invention relates to a data visualisation system and method particularly but not solely designed for visualising data relating to warranties for consumer goods.

### BACKGROUND TO INVENTION

The low cost of data storage hardware has led to the collection of large volumes of data. Merchants, for example, generate and collect large volumes of data during the course of their business. To compete effectively, it is necessary for a merchant to be able to identify and use information hidden in the collected data. This data could include information collected when goods are returned for replacement or repair during a warranty period. The task of identifying this hidden information has proved very difficult for merchants.

Traditionally, analysis of data has been achieved by running a query on a set of data records stored on a database. The merchant or other party first creates a hypothesis, converts this hypothesis to a query, runs the query on the database, and interprets the results obtained with respect to the original hypothesis.

One disadvantage of this verification-driven hypothesis approach is that the merchant must form the desired hypothesis in advance. This is merely confirming what the merchant already suspects and does not provide the merchant with information which may be unexpected. Another disadvantage is that the merchant needs to have available the technical knowledge to formulate the appropriate queries.

Our patent specification WO 00/77682 to Compudigm International Limited entitled “Data Visualisation System and Method” describes a system and method of presenting visualisations in an intuitive manner for various types of merchants. It will be particularly desirable to extend the types of data presented to merchants to enhance the effectiveness and visual appeal of these visualisations.

### SUMMARY OF INVENTION

In one preferred form the invention comprises a data visualisation system comprising a data value memory in which is maintained an interaction database of interaction data representing interactions between customers and merchants involving one or more items; a retrieval device configured to retrieve from the interaction database data representing interactions between customers and merchants and to construct a finite set of data values from the retrieved data; and a display arranged to display a graphical representation of at least one item, and to superimpose one or more contoured representations of the data values on the graphical representation of the item, such that each data value is displayed as a local maximum.

In a further preferred form the invention comprises a method of data visualisation comprising the steps of maintaining in an interaction database interaction data representing interactions between customers and merchants involving one or more items; retrieving from the interaction database data representing interactions between customers and merchants; constructing a finite set of data values from the retrieved data; displaying a graphical representation of at least one merchant; and superimposing a contoured representation of the data values on the graphical representation of the merchant such that each data value is displayed as a local maximum.

In yet a further preferred form the invention comprises a data visualisation computer program comprising an interaction database of interaction data maintained in a memory, the interaction data representing interactions between customers and merchants involving one or more items; a retrieval component configured to retrieve from the interaction database data representing interactions between customers and merchants and to construct a finite set of data values from the retrieved data; and a display component configured to display a graphical representation of at least one item, and to superimpose one or more contoured representations of the data values on the graphical representation of the item such that each data value is displayed as a local maximum.

### BRIEF DESCRIPTION OF THE FIGURES

Preferred forms of the warranty data visualisation system and method will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 is a preferred representation generated in accordance with the invention;

FIG. 4 is a flow chart of a preferred form of the invention; and

FIG. 5 is another preferred representation generated in accordance with the invention.

### DETAILED DESCRIPTION OF PREFERRED FORMS

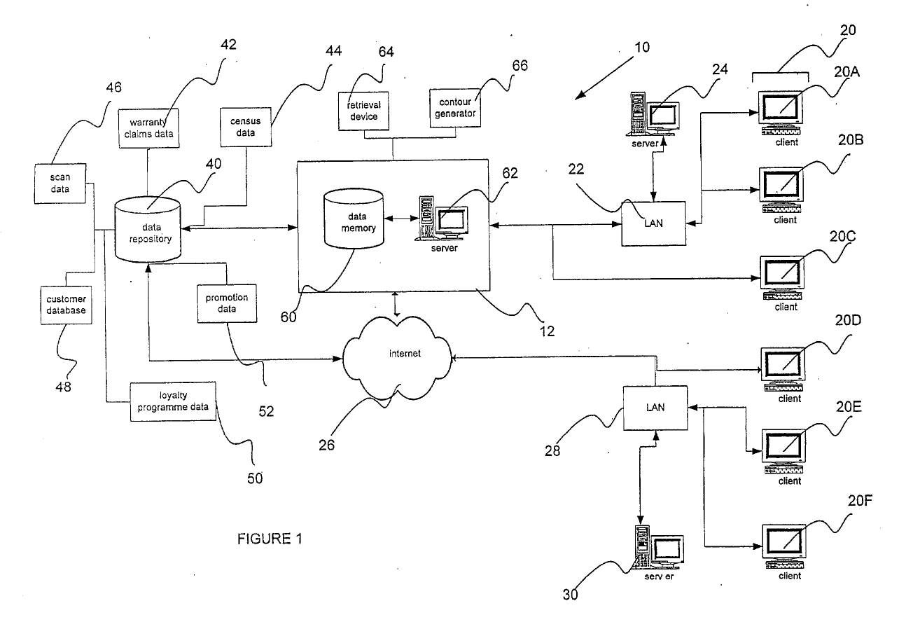

FIG. 1 illustrates a block diagram of the preferred system 10 in which one form of the present invention may be implemented. The system includes one or more clients 20 for example 20A, 20B, 20C, 20D, 20E and 20F, which each may comprise a personal computer or workstation described below. Each client 20 is interfaced to a workstation 12 as shown in FIG. 1. Each client 20 could be connected directly to the workstation 12, could be connected through a local area network or LAN, or could be connected through the Internet.

Clients 20A and 20B, for example, are connected to a network 22, such as a local area network or LAN. The network 22 could be connected to a suitable network server 24 and communicate with the workstation 12 as shown. Client 20C is shown connected directly to the workstation using for example a serial connection or WAP connection. Clients 20D, 20E and 20F are shown connected to the workstation through the Internet 26 with a dial-up connection and clients 20E and 20F are shown connected to a network 28 such as a local area network or LAN, with the network 28 connected to a suitable network server 30.

The preferred system 10 further comprises a data repository 40, for example a data warehouse maintained in a memory. It is envisaged that the data repository may alternatively comprise a single database, a collection of databases, or a data mart. The preferred data repository 40 includes data from a variety of sources. The data repository may include, for example, interaction data in the form of warranty claims data 42 representing interactions between customers and merchants, as will be more particularly described below. The data repository may also include data from other sources, for example, census data 44, scan data 46 obtained from scanning bar-codes on products, data from merchant customer databases 48, data from merchant loyalty programmes 50 and/or promotion data 52 held by a merchant or other organisation.

The personal computer or workstation 12 preferably operates under the control of appropriate operating and application software, and has a data memory connected to a server 62. The invention includes a retrieval device 64 which in one form comprises a software implemented query enabling retrieval of data from the data repository 40. The data retrieved using the retrieval device 64 is processed with the server 62. A contour generator 66 which in one form comprises a computer implemented software program generates a contoured representation or series of contour lines in order to display a representation of the data on a client workstation 20, as will be described below.

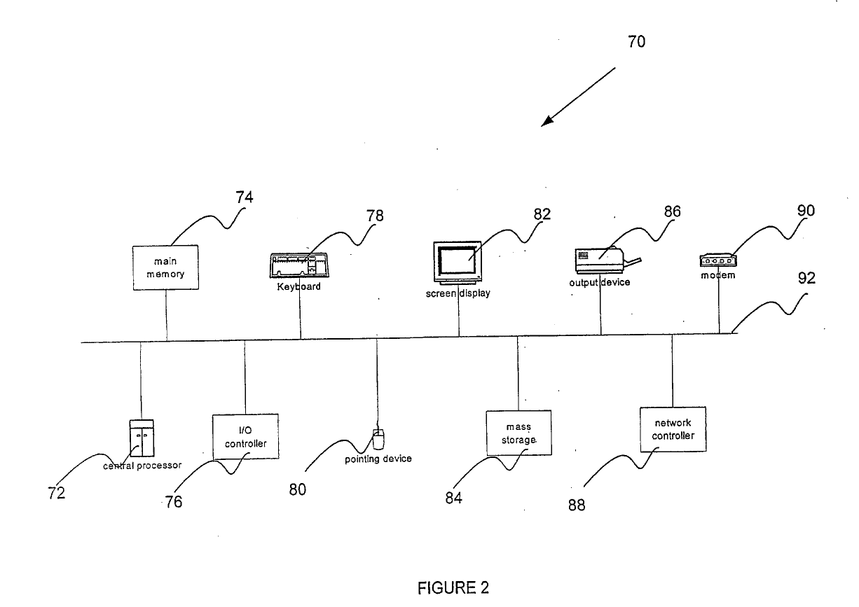

FIG. 2 shows the preferred system architecture of a client 20 or workstation 12. The computer system 70 typically comprises a central processor 72, a main memory 74 for example RAM and an input/output controller 76. The computer system 70 also comprises peripherals such as a keyboard 78, a pointing device 80 for example a mouse, a display or screen device 82, a mass storage memory 84 for example a hard disk, floppy disk or optical disc, and an output device 86 for example a printer. The system 70 could also include a network interface card or controller 88 and/or a modem 90. The individual components of the system 70 could communicate through a system bus 92.

It is envisaged that the invention have a wide area of application and the nature and format of the data stored in the data repository 40 will be different for each application. In each case, the workstation 12 is arranged to display a contoured representation of data on a screen display on a client workstation 20.

Typically, a merchant will operate in a commercial premises or store from which a customer purchases goods. The merchant could include a manufacturer of consumer goods, a distributor of consumer goods, or a retailer of consumer goods. A customer will typically purchase goods from the merchant under warranty. The customer could include a distributor or reseller, retailer or a consumer.

Where the goods need replacement or repair during the warranty period, the customer may return the goods to the merchant, and this interaction generates interaction data which is migrated to the data repository 40. The manufacturer typically collects data on the customer returning the product in the form of warranty forms. These warranty forms could include for example the name, age, gender, address, occupation and so on of the customer, together with data on how the customer uses the product. The manufacturer could also record against these warranty forms the faults and/or the repairs or replacements needed on the product or components of the product. These warranty claims are typically stored in a warranty claims database 42.

The warranty claims could be stored in the warranty claims database 42, the database having a number of records in a relational format. Each record may include a merchant identifier used to identify a particular merchant, and where a merchant operates from more than one geographic location, the merchant identifier or some other identifier included in the record may identify the geographic location in which the interaction occurs.

The record could also include a customer identifier. The merchant may assign identifiers to frequent customers, which are then used by the customer during interactions with the merchant. The customer identifiers could be linked to further data on a particular customer or customers and this data could be stored in loyalty programme database 50 and could be migrated to the data repository 40.

Where the merchant operates retail premises, the merchant may have installed apparatus for reading the bar-codes of products sold. Alternatively, each product may be identified by a code assigned by the merchant which is recorded at the time of sale. Such data is stored in a scan database 46 and could be migrated to the data repository 40. In this way, the record may also include a suitable item or goods identifier, for example a product code to identify which goods were involved in the interaction.

The record may also include data such as the date and/or time at which the interaction between the customer and merchant took place and/or the cash value of the transaction.

The interaction data is migrated to the data repository 40, generally by way of daily updates or in real time. It is advantageous to cleanse, catalogue and validate the interaction data during migration of the data to the data repository, and this task could be performed by either the merchant or by a third party. Once stored in the data repository 40, the data could be linked to other sources of data for subsequent retrieval, for example the census data 44, scan data 46, data from the merchant customer database 48, data from a merchant loyalty programme 50 and/or promotion data 52 held by the merchant.

The data repository 40 could be maintained by a merchant or alternatively could be maintained by a third party. Updates to the data repository could be carried out by the merchant directly, or alternatively the merchant could provide batched data to a third party for updating the data. Alternatively, a third party could be entrusted with the task of collecting the interaction data and migrating the data to the data repository.

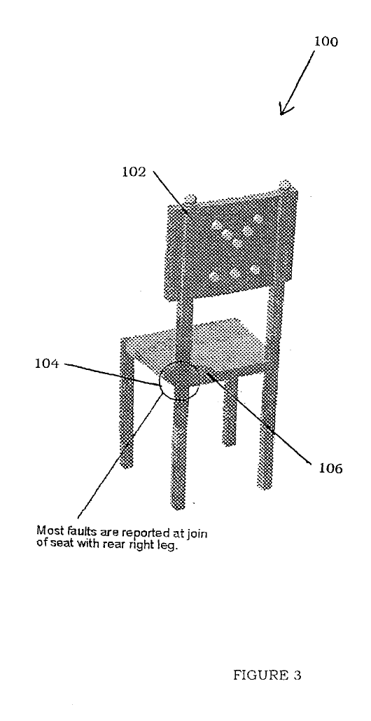

FIG. 3 illustrates at 100 one example of a display generated by the system where the merchant manufactures consumer products. In this example, a representation of the manufactured goods is generated and displayed. The graphical representation comprises a perspective view of the item, in this case a chair. It will be appreciated that the particular representation generated will be varied according to the nature of the data represented.

The representation 100 is arranged to display the faults present in a manufactured chair 102. The number of faults is preferably graphically represented adjacent or near to the representation of the chair. There are a finite number of potential faults in a manufactured article, and the individual faults generated from the potential faults represent a finite set of data values. These data values are graphically illustrated as data points in the representation 100. For example, the join of the seat with one rear leg indicated at 104 has a high instance of faults and these faults are indicated graphically by representation 106 adjacent to or near the source of the fault.

The preferred representation 100 is colour-coded and the number of faults for each potential fault is illustrated by representing the corresponding data points in the appropriate colour to represent the correct number of faults for each article.

The areas of the representation 100 around each data point are shown as contours, for example 106. The nature of the contours for each data point are preferably represented to gradually drop off or fall away from each data point. Each data point could be represented by x and y co-ordinates indicating the relative position of each data point in the representation. Each data point could also have a z value representing the height or magnitude of the data point above the surface of the article. This z value could indicate, for example, the number of faults or data value at a particular data point. The contour lines represent z data values which are less than the data value of the data point around which the contour lines are displayed. In this way, each data value is therefore centred on a data point. Each data point is displayed as a local maximum as surrounding values drop off or fall away around each point.

This contoured method of representing data values is more particularly described in our patent specification WO 00/77862 to Compudigm International Limited filed on Jun. 14, 2000 entitled “Data visualisation system and method” which is incorporated by reference. The data value of each data point represents the apex of a bell-shaped curve. As x and y values in the representation are increased or decreased, the z value at the new position in the representation will change.

Each data point could have an axis and a maximum value at that axis. At a distance r from the axis, the drop in z value is preferably calculated by the following drop-off function:

$$f ( r ) = \frac{1}{1 + {( \frac{r}{a} )}^{p}}$$

The value of p is preferably 2 or 3. As the value of p is increased, the data point is represented having a steeper shoulder and a flatter peak with steeper walls.

The value of a defines the horizontal distance between the axis and the point of maximum drop-off of the resulting curve, which in practice defines the width of the contoured hill. The value of a could be, for example, the point of “half height” of the value. Small values of a will result in fine detail in a contoured representation and larger values of a will result in less detailed representation.

The difference in the present invention is that the distance r is not measured as a distance from the source point across the plane of the flat image. The value of r is instead measured as the shortest distance across the surface of the item from the source point.

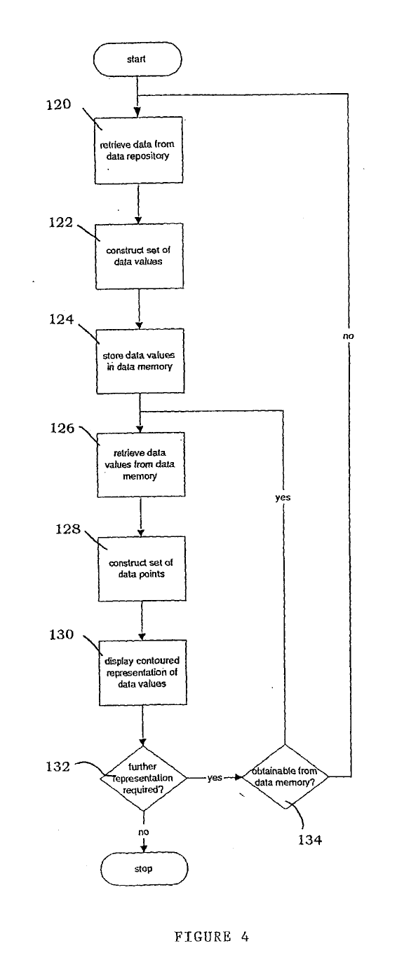

FIG. 4 illustrates the preferred method of operation of the invention. As shown at 120, data is retrieved from the data repository 40 using a suitable query by the retrieval device 64. The retrieved data could include data representing interactions between customers and merchants, where this data is stored in the data repository 40. The retrieved data could include the number of warranty claims for a particular article over a specified period.

As shown at 122, a set of data values is constructed from the retrieved data. This set of data values could include for example, the number of claims made on a particular article over a pre-defined period, or the number of claims relating to a common fault on an article. It is envisaged that the set of data values could be stored in data value memory 60 to increase efficiency of the system as indicated at 124, which could comprise volatile main RAM or non-volatile mass storage of the workstation on which the invention is implemented.

Referring to step 126, the set of data values are retrieved from the volatile or non-volatile data memory and as shown at 128, a set of data points is constructed to represent the data values. Appropriate x and y values are generated for each data point to space the data points over a generated representation. The z values for each data point are also calculated based on individual data values.

Referring to step 130, a contoured representation of the data values is generated by the contour generator and displayed on a client workstation 20. The individual drop-off for each data point is calculated and displayed in the appropriate colour and shading corresponding to the z value at each point.

It is envisaged that the invention generate individual displays of contoured representations. It is also envisaged that the invention generate animated sequences of representations by generating two or more “still” representations at various time intervals and superimposing successive representations over earlier representations to generate an animated sequence in which a succession of data points appear to move on a display.

As indicated at 132, where such an animated sequence is required, further representations will be needed and if the necessary data is obtainable from the data memory as indicated at 134, it is retrieved from the data memory as indicated at 126, otherwise further data is retrieved from the data repository at 120.

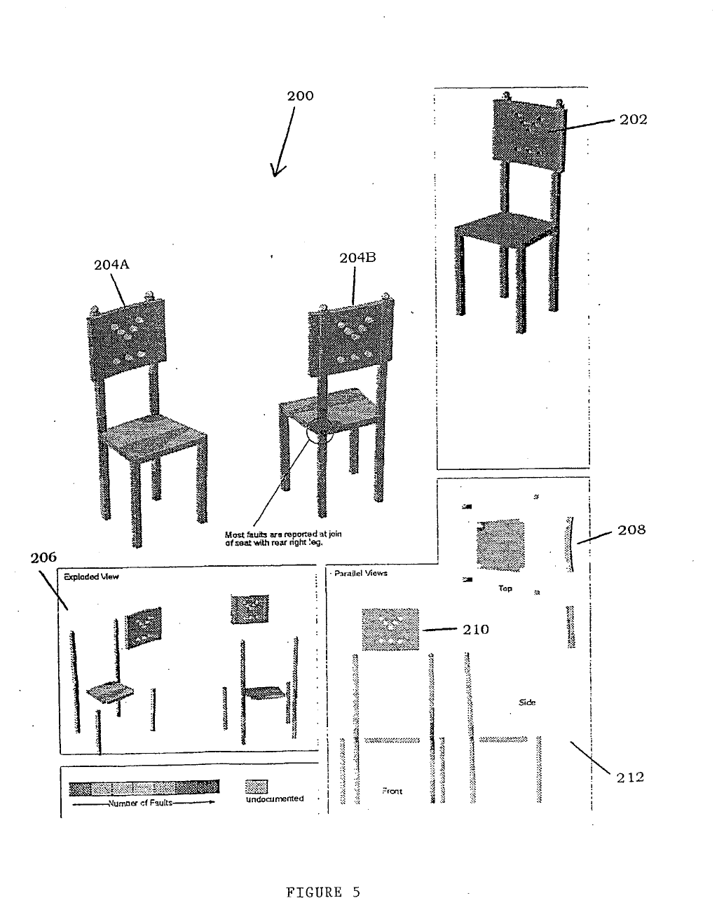

FIG. 5 shows a further graphical representation of merchant goods generated and displayed on the screen display of a client workstation 20. Where a merchant manufactures chairs, the graphical representation could include various views of the chair. The representation 200 could include a main perspective view 202 which could act as an index for the representation. Where the system generates more than one representation for example, representation 200 could serve as a label by which the user could select the desired representation.

As described above, the representation 200 could also include one or more perspective views, for example 204A and 204B over which the warranty claims data is contoured. The representation may include further views, for example exploded perspective views 206, exploded plan views 208, exploded front views 210 and exploded side views 212.

It will be appreciated that where the merchant manufactures, distributes or sells different goods or items, the various items manufactured, distributed or sold could appear in representation 200.

As described above, the invention is arranged to superimpose a representation of the data retrieved from the data repository 40 on the representation or representations of the goods. As shown in FIG. 7, the invention displays the number or frequency of faults that were reported at the join of the seat with one of the rear legs during a pre-determined period.

The invention could generate individual still representations such as that shown in FIG. 7. Alternatively, the invention could generate a series of representations at time intervals. By overlaying subsequent representations over earlier representations, the rate at which reported faults in a component or components of the product change over a time period can be observed.

The system may also overlay text over the representation. For example, different faults in the products could be identified by appropriate labels.

The system is arranged to present to a user 3-dimensional images of goods manufactured, distributed or sold by a merchant, for example a specific brand and model of a car or a particular chair design. Data representing faulty or damaged components of a product are visually mapped to this representation. The merchant can then view a representation generated by the invention to visualise which components are failing or being damaged while under warranty.

For example, a particular model of chair could be consistently developing stress cracks where the right rear leg joins the seat, as shown in FIG. 7. This fault could be due to a number of factors, for example design or construction faults, improper use and so on. The chair manufacturer would be able to get feedback on the performance of their product, and modify the design if necessary to fix the problem. The merchant would also be better prepared to correct an influx of chairs which are expected to be returned within the warranty period.

It is also envisaged that where the goods require replacement or repair during the warranty period, that the merchant collect information on the merchant returning the product, by having the customer complete warranty forms and documents. The merchant could record against these warranty forms or documents the repairs or replacements needed on the product or components of the product. The merchant could collect a range of information about any customer who has returned the product due to some perceived or actual fault, including name, age, gender, address, occupation and so on, together with data on how the customer uses the product.

The merchant could then view a product representation to visualise which components are failing or being damaged under warranty, then further breakdown the image into demographic categories to view faults in the products, for example, Ford Festiva 1.31t. hatchback cars sold to women over 40 years of age in New Zealand could develop a particular fault. This particular make of car could have suspension exhibiting a higher failure rate on New Zealand roads then elsewhere for a particular driver. The system could generate a 3-dimensional visualisation for the customer profile of the New Zealand owners of that particular model, and the merchant could make design adjustments to suit.

The invention could be applied to any of the manufacturing and consumer industries where warranties are offered to the customer for the product and/or components of the product. The invention could also include the sale of spare parts, and could also collect data on repairs needed to be made to products after the warranty period has expired.

The foregoing describes the invention including preferred forms thereof. Alterations and modifications as will be obvious to those skilled in the art are intended to be incorporated within the scope hereof as defined by the accompanying claims.

1. A data visualisation system comprising;
a data value memory in which is maintained an interaction database of interaction data representing interactions between customers and merchants involving one or more items;
a retrieval device configured to retrieve from the interaction database data representing interactions between customers and merchants and to construct a finite set of data values from the retrieved data; and
a display arranged to display a graphical representation of at least one item, and to superimpose one or more contoured representations of the data values on the graphical representation of the item, such that each data value is displayed as a local maximum.

2. A data visualisation system as claimed in claim 1 wherein the interaction data represents purchased items returned to a merchant by a customer, the interaction data including one or more faults in the returned item.

3. A data visualisation system as claimed in claim 2 wherein the interaction data includes an item identifier.

4. A data visualisation system as claimed in any one of the preceding claims wherein the interaction data includes one or more merchant identifiers.

5. A data visualisation system as claimed in any one of the preceding claims wherein the interaction data includes one or more customer identifiers.

6. A method of data visualisation comprising the steps of:
maintaining in an interaction database interaction data representing interactions between customers and merchants involving one or more items;
retrieving from the interaction database data representing interactions between customers and merchants;
constructing a finite set of data values from the retrieved data;
displaying a graphical representation of at least one item; and
superimposing one or more contoured representations of the data values on the graphical representation of the item such that each data value is displayed as a local maximum.

7. A method of data visualisation as claimed in claim 6 wherein the interaction data represents purchased items returned to a merchant by a customer, the interaction data including one or more faults in the returned item.

8. A method of data visualisation as claimed in claim 7 wherein the interaction data includes an item identifier.

9. A method of data visualisation as claimed in any one of claims 6 to 8 wherein the interaction data includes one or more merchant identifiers.

10. A method of data visualisation as claimed in any one of claims 6 to 9 wherein the interaction data includes one or more customer identifiers.

11. A data visualisation computer program comprising:
an interaction database of interaction data maintained in a memory, the interaction data representing interactions between customers and merchants involving one or more items;
a retrieval component configured to retrieve from the interaction database data representing interactions between customers and merchants and to construct a finite set of data values from the retrieved data; and
a display component configured to display a graphical representation of at least one item, and to superimpose one or more contoured representations of the data values on the graphical representation of the item, such that each data value is displayed as a local maximum.

12. A data visualisation computer program as claimed in claim 11 wherein the interaction data represents purchased items returned to a merchant by a customer, the interaction data including one or more faults in the returned item.

13. A data visualisation computer program as claimed in claim 12 wherein the interaction data includes an item identifier.

14. A data visualisation computer program as claimed in any one of claims 11 to 13 wherein the interaction data includes one or more merchant identifiers.

15. A data visualisation computer program as claimed in any one of claims 11 to 14 wherein the interaction data includes one or more customer identifiers.

16. A data visualisation computer program as claimed in any one of claims 11 to 15 embodied on a computer readable medium.
